(19) United States
(12) Patent Application Publication
(10) Pub. No.: US 2012/0042108 A1
(43) Pub. Date: Feb. 16, 2012

(54) USB Computer

(75) Inventor: Allen Nejah, San Jose, CA (US)

(73) Assignee: SunMan Engineering, Inc., San Jose, CA (US)

(21) Appl. No.: 12/855,958

(22) Filed: Aug. 13, 2010

(51) Int. Cl. G06F 13/20; G06F 13/00

(52) U.S. Cl. 710/301; 710/313

(57) ABSTRACT

A Universal Serial Bus (USB) computer has a small form factor similar to a USB flash drive. The USB computer is connected by USB to a host computer to utilize the host computer's resources. The USB computer receives a user input provided on the host computer's input device over the USB connection, executes a local user application in response to the user input, and provides a graphical output to the host computer's output device. The USB computer includes a client application that communicates with a host application installed on the host computer. The host application causes the host computer to provide control over the host computer's resources to the USB computer.

### FIELD OF INVENTION

This invention relates to a portable computer embodied in a USB dongle.

### DESCRIPTION OF RELATED ART

Laptops or notebooks are personal computers designed for mobile use. Laptops may be small and light enough to sit on a person's lap while in use. Laptops integrate most of the typical components of desktop computers, including a display, a keyboard, a pointing device, speakers, and usually including a battery, into a single small and light unit. Laptops are usually notebook-shaped with thicknesses between 0.7 to 1.5 inches and dimensions ranging from 10 by 8 inches (13″ display) to 15 by 11 inches (17″ display) and up. Modern laptops weigh 3 to 12 pounds.

Netbooks area laptops that are light-weight, economical, energy-efficient and especially suited for wireless communication and Internet access. While the devices range in size from below 5 inches to over 12, most are between 7 and 11 inches and weigh between 2 to 3 pounds.

### SUMMARY

In one or more embodiments of the present disclosure, a Universal Serial Bus (USB) computer has a small form factor. The USB computer includes a USB connector for connecting to a host computer to establish a USB connection, a USB controller coupled to the USB connector, a nonvolatile memory storing a client application and a user application, and a processor coupled to the USB controller and the nonvolatile memory. The processor executes the client application to (1) establish communication with a host application installed on the host computer through the USB connection, the host application providing control over the host computer to the client application so the USB computer is a master device and the host computer is a slave device, (2) receive a user input from the host application, the user input being provided through an input device of the host computer, and (3) to transmit a graphical output in response to the user input to the host application, the host application causing the host computer to display the graphical output on an output device of the host computer. The processor executes the user application to generate the graphical output in response to the user input.

In one or more embodiments of the present disclosure, a method is provided for a USB computer to utilize resources of a host computer. The method includes (1) executing a client application to communicate with a host application installed on a host computer through a USB connection between the USB computer and the host computer, the host application providing control over the host computer to the client application so the USB computer is a master device and the host computer is a slave device, (2) receiving a user input from the host computer, the user input being provided through an input device of the host computer, (3) executing an application on the USB computer to generate a graphical output in response to the user input, and (4) transmitting the graphical output to the host application, the host application causing the host computer to display the graphical output on an output device of the host computer.

In one or more embodiments of the present disclosure, a method is provided for a host computer to provide its resources to a USB computer. The method includes (1) detecting a USB connection between the host computer and the USB computer, (2) executing a host application, wherein the host application provides control of the host computer to the USB computer so the USB computer is a master device and the host computer is a slave device, (3) receiving a user input through an input device of the host computer, (4) transmitting the user input to the USB computer over the USB connection, (4) receiving a graphical output from the USB computer over the USB connection, and (5) displaying the graphical output through an output device of the host computer.

### BRIEF DESCRIPTION OF THE DRAWINGS

In the drawings:

FIG. 1 is a block diagram of a USB computer using peripheral devices of a computer in one or more embodiments of the present disclosure;

FIG. 2 is a block diagram of the USB computer in FIG. 1 in one or more embodiments of the present disclosure; and

FIG. 3 is a flowchart of a method for the USB computer of FIG. 1 to use input/output devices of the computer of FIG. 1 in one or more embodiments of the present disclosure.

Use of the same reference numbers in different figures indicates similar or identical elements.

### DETAILED DESCRIPTION

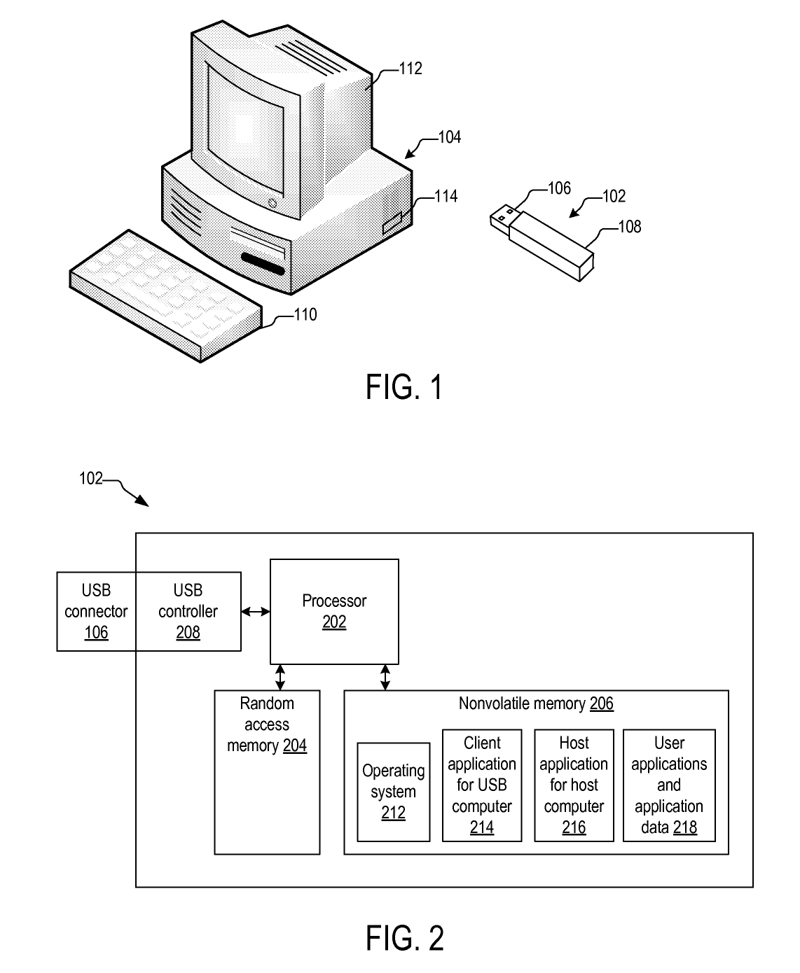

FIG. 1 is a block diagram of a USB computer 102 using input/output (I/O) devices of a host computer 104 in one or more embodiments of the present disclosure. USB computer 102 has a small form factor similar to a USB dongle such as a USB flash drive. USB computer 102 is typically equal to or less than 6 by 2 by 2 inches. USB computer 102 has a USB connector 106 at one end of a case 108 that encloses internal electronic components described later in FIG. 2. USB connector 106 may be a type A male connector. USB computer 102 is devoid of I/O devices including a keyboard, a mouse, and a monitor.

Host computer 104 is a desktop or a laptop computer installed with a host application 216 (FIG. 2). Host computer 104 includes one or more input devices 110, such as a keyboard and a mouse, one or more output devices 112, such as a monitor, a processor, a random access memory (RAM), a nonvolatile memory, such as a hard disk drive, and a USB port 114. USB connector 106 of USB computer 102 can be inserted into USB port 114 of host computer 104. Software on USB computer 102 and host computer 104 allows the USB computer to become a master device and the host computer to become a slave device to the USB computer. A user can use input devices 110 and output devices 112 of host computer 104 to interact with USB computer 102.

FIG. 2 is a block diagram of USB computer 102 in FIG. 1 in one or more embodiments of the present disclosure. USB computer 102 includes a processor 202, a RAM 204 coupled to the processor, a nonvolatile memory 206 coupled to the processor, a USB controller 208 coupled to the processor, and USB connector 106 coupled to the USB controller. Nonvolatile memory 206 may be a flash memory. Nonvolatile memory 206 stores an operating system (OS) 212, a client application 214 for USB computer 102, a host application 216 for host computer 104, and one or more user applications 218 and their data. Processor 202 executes OS 212 to run client application 214 and applications 218. Alternatively client application 214 may be part of OS 212. Client application 214 allows USB computer 102 to control host computer 104 through host application 216 installed on the host computer.

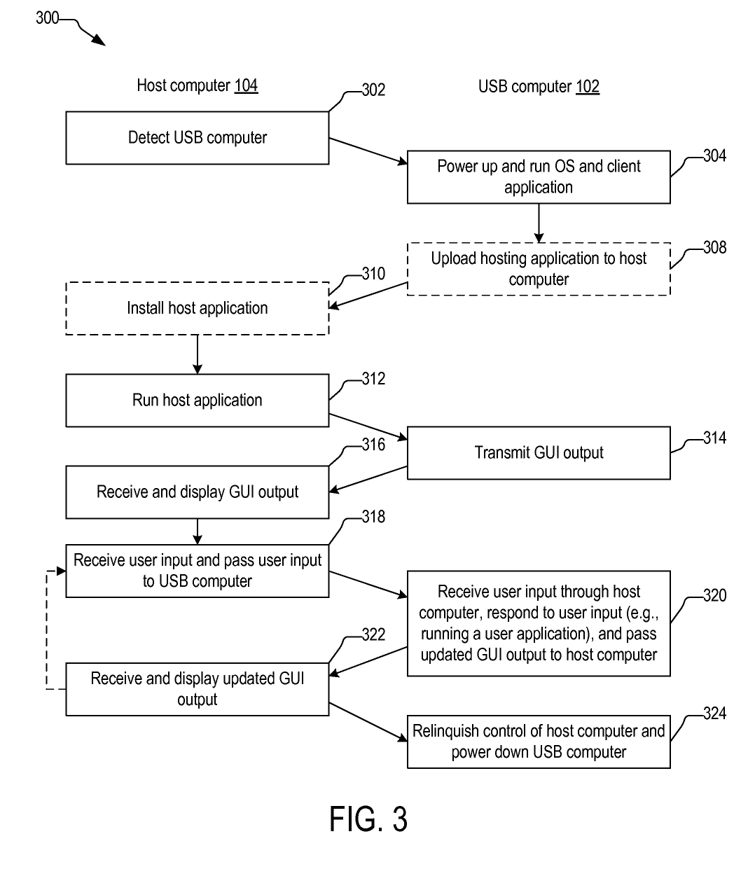

FIG. 3 is a flowchart of a method 300 for USB computer 102 in FIG. 1 to use I/O devices of computer 104 in FIG. 1 in one or more embodiments of the present disclosure. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation. Method 300 may begin in block 302.

In block 302, the processor of host computer 104 detects the presence of USB computer 102 when a user inserts the USB computer into USB port 114 of the host computer.

In block 304, processor 202 of USB computer 102 powers up from the power supplied by the USB connection between USB computer 102 and host computer 104. Processor 202 then runs OS 212 and client application 214. OS 212 provides a graphical user interface (GUI) for the user to use USB computer 102.

In optional block 308, processor 202 of USB computer 102 uploads host application 216 to host computer 104 for installation. This may be done automatically. Alternatively, host computer 104 prompts the user to select and install a software application for USB computer 102 when it does not recognize USB computer 102, and the user manually selects host application 216 on USB computer 102. The host application 216 may be located on an installation CD or the Internet.

In optional block 310, the processor of host computer 104 installs host application 216.

In block 312, the processor of host computer 104 runs host application 216. The processor may do this in response the presence of USB computer 102 or under user command. Host application 216 establishes communication with client application 214 on USB computer 102 over the USB connection. Host application 216 grants control of host computer 104 to client application 214 so USB computer 102 may use input devices 110 and output devices 112 of host computer 104. For example, host application 216 causes the processor to display the GUI output from of USB computer 102 on a monitor 112 of host computer 104, and to transmit user inputs from a keyboard and/or a mouse 110 of host computer 104 to USB computer 102.

In block 314, processor 202 of USB computer 102, running client application 214, transmits the GUI output of OS 212 to host computer 104 over the USB connection.

In block 316, the processor of host computer 104, running host application 216, displays the GUI output on monitor 112.

In block 318, the processor of host computer 104 receives user input on keyboard and/or mouse 110. The processor, running host application 216, transmits the user input to USB computer 102 over the USB connection. For example, the user input may be the selection to run a user application 218 on USB computer 102 or a command to a running user application on the USB computer.

In block 320, processor 202 of USB computer 102, running client application 214, receives the user input from host computer 104 over the USB connection and responds to the user input. For example, processor 202 starts a user application 218 or provides a command to a running user application, updates the GUI output, and transmits the updated GUI output to host computer 104 over the USB connection. Even without user input, processor 202 periodically updates the GUI output with any changes.

In block 322, the processor of host computer 104 receives the updated GUI output over the USB connection. The processor, running host application 216, displays the updated GUI output on monitor 112. Block 322 optionally loop back to block 318 when the user continues to use USB computer 102. When the user is finished, block 322 is followed by block 324.

In block 324, processor 202 of USB computer 102 relinquishes control over host computer 104 and powers down. This allows the user to use host computer 104 and its user applications for other purposes. In some embodiments, host application 216 uninstalls itself so host computer 104 returns to its initial state prior to the installation of the host application.

Various other adaptations and combinations of features of the embodiments disclosed are within the scope of the present disclosure. Numerous embodiments are encompassed by the following claims.

What is claimed is:

1. A Universal Serial Bus (USB) computer having a small form factor, the USB computer comprising:
a USB connector for connecting to a host computer to establish a USB connection;
a USB controller coupled to the USB connector;
nonvolatile memory storing:
a client application; and
an application; and
a processor coupled to the USB controller and the nonvolatile memory, the processor executing:
the client application to:
establish communication with a host application installed on the host computer through the USB connection, the host application providing control over the host computer to the client application so the USB computer is a master device and the host computer is a slave device;
to receive a user input from the host application, the user input being provided through an input device of the host computer; and
to transmit a graphical output in response to the user input to the host application, the host application causing the host computer to display the graphical output on an output device of the host computer; and
the application to generate the graphical output in response to the user input.

2. The USB computer of claim 1, wherein the USB connector is a male USB connector.

3. The USB computer of claim 2, wherein the computer has a form factor of a USB dongle.

4. The USB computer of claim 3, wherein the form factor is less than 6 by 2 by 2 inches.

5. The USB computer of claim 4, wherein the USB connector is the only interface to external devices.

6. The USB computer of claim 1, further comprising a random access memory, wherein the nonvolatile memory comprises a flash memory.

7. The USB computer of claim 1, wherein the USB computer is devoid of a display, a keyboard, and a pointing device.

8. A method for a Universal Serial Bus (USB) computer to utilize resources of a host computer, the method comprising:
executing a client application to communicate with a host application installed on a host computer through a USB connection between the USB computer and the host computer, the host application providing control over the host computer to the client application so the USB computer is a master device and the host computer is a slave device;
receiving a user input from the host computer, the user input being provided through an input device of the host computer;
executing an application on the USB computer to generate a graphical output in response to the user input; and
transmitting the graphical output to the host application, the host application causing the host computer to display the graphical output on an output device of the host computer.

9. The method of claim 8, further comprising:
transmitting the host application to the host computer for installing the host application on the host computer.

10. A method for a host computer to provide its resources to a Universal Serial Bus (USB) computer, the method comprising:
detecting a USB connection between the host computer and the USB computer;
executing a host application, wherein the host application provides control of the host computer to the USB computer so the USB computer is a master device and the host computer is a slave device;
receiving a user input through an input device of the host computer;
transmitting the user input to the USB computer over the USB connection;
receiving a graphical output from the USB computer over the USB connection; and
displaying the graphical output through an output device of the host computer.

11. The method of claim 10, further comprising:
receiving the host application from the USB computer over the USB connection; and
installing the host application.

12. The method of claim 10, wherein executing the host application is in response to detecting the USB connection.
